(19) United States
(12) Patent Application Publication
(10) Pub. No.: US 2024/0260583 A1
(43) Pub. Date: Aug. 8, 2024

(54) ANTIVIRAL COMPOSITION AND ANTIVIRAL MEMBER

(71) Applicants: TAKACHIHO SHIRASU CORP., Miyazaki (JP); NATIONAL INSTITUTE OF TECHNOLOGY, Tokyo (JP)

(72) Inventors: Masahiro SHINTOME, Miyazaki (JP); Taro NOGUCHI, Miyazaki (JP); Daisuke NOGUCHI, Miyazaki (JP)

(73) Assignees: TAKACHIHO SHIRASU CORP., Miyazaki (JP); NATIONAL INSTITUTE OF TECHNOLOGY, Tokyo (JP)

(21) Appl. No.: 18/563,062

(22) PCT Filed: May 16, 2022
(86) PCT No.: PCT/JP2022/020319

§ 371 Date: Nov. 21, 2023

(30) Foreign Application Priority Data
May 28, 2021 (JP) 2021-089882

(51) Int. Cl. A01N 61/00; A01N 25/34

(52) U.S. Cl. CPC A01N 61/00; A01N 25/34

(57) ABSTRACT

Provided is an antiviral composition including an inorganic compound that includes an antiviral property and a porous structure. Also provided is an antiviral member including a base material and the antiviral composition installed on the base material. It is possible to provide an antiviral composition which is capable of adsorbing viruses floating in the air on the surface thereof and eliminating them, and has excellent handling and excellent safety, and to provide an antiviral member using the antiviral composition.

### TECHNICAL FIELD

The present invention relates to an antiviral composition and an antiviral member.

### BACKGROUND

In recent years, what are called “pandemics” in which infectious diseases caused by viruses such as novel coronavirus infection (COVID-19), severe acute respiratory syndrome (SARS), norovirus, and avian influenza, as well as bacteria such as O157, spread rapidly in a short period of time, have become a problem. Since such diseases threaten human life, countermeasures are urgently needed worldwide.

Thus, the development of antibacterial and antiviral agents that exhibit antibacterial and antiviral activity against various bacteria and viruses is actively underway. As exemplified by Japanese Unexamined Patent Application Publication No. 2015-120896 (Patent Literature 1), there are antiviral agents made from inorganic oxide fine particles containing antiviral metal components such as silver, copper, and zinc.

In addition, as exemplified by Japanese Unexamined Patent Application Publication No. 2000-263706 (Patent Literature 2), there is an example where a composition containing a high molecular substance in which an organic antibacterial agent component is linked to a main chain or side chain, a hydrophilic substance mixed or linked to the high molecular substance, and a curing agent is added to plastics, fibers, and the like, and they are applied to masks, filters, paints, and the like.

In addition, it has been well known that metal ions in small quantities of silver, copper, zinc, and the like have antibacterial and antifungal effects, and such antibacterial metal ions are added to bactericides and disinfectants in the form of metal salts such as silver nitrate, for example, and are widely used in various fields.

### SUMMARY OF THE INVENTION

### Technical Problem

Any antibacterial and antiviral agent exhibits the antibacterial and antiviral activity only against bacteria and viruses attached on the surface of antibacterial and antiviral agents, and has no effect on bacteria and viruses floating in the air. Chemical agents such as hypochlorous acid and hydrogen peroxide have been used to eliminate the pathogenicity of microorganisms and viruses floating in the air, but these chemical agents have an issue of having a large impact on the human body or the environment. In addition, there is an issue of low durability of the effect.

Furthermore, the usage of metal salts is limited because they are handled in the form of aqueous solutions, and silver nitrate has a strong mucous membrane irritation to the human body, resulting in many safety issues.

The present invention provides an antiviral composition which is capable of adsorbing viruses floating in the air on the surface thereof and eliminating them and has excellent handling and excellent safety, and provides an antiviral member using the antiviral composition.

### Solution to Problem

According to a technical aspect of the present invention, an antiviral composition includes an inorganic compound including an antiviral property and a porous structure. According to another technical aspect of the present invention, the inorganic compound is made from Shirasu.

### BRIEF DESCRIPTION OF DRAWINGS

FIG. 1 is a cross-sectional view of an antiviral composition according to an embodiment of the present invention, schematically illustrating the antiviral composition.

FIG. 2 is a diagram illustrating an example of an antiviral member according to the embodiment of the present invention.

FIG. 3 is a diagram illustrating an example of the antiviral member according to the embodiment of the present invention.

FIG. 4 is a diagram illustrating an example of the antiviral member according to the embodiment of the present invention.

FIG. 5 is a diagram illustrating an effect of the antiviral composition according to the embodiment of the present invention.

FIG. 6 is a diagram illustrating an effect of the antiviral composition according to the embodiment of the present invention.

FIG. 7 is a diagram illustrating an effect of the antiviral composition according to the embodiment of the present invention.

FIG. 8 is a diagram illustrating effects of the antiviral composition according to the embodiment of the present invention.

### DETAILED DESCRIPTION OF THE INVENTION

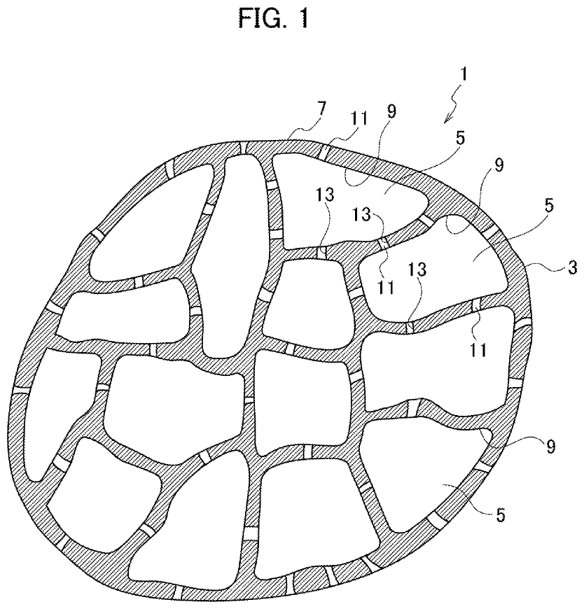

An antiviral composition 1 according to an embodiment of the present invention includes an inorganic compound 3. The inorganic compound 3 has an antiviral property. As illustrated in FIG. 1, the inorganic compound 3 has a porous structure in which many pores (air bubbles) 5 are formed and a large number of minute air bubbles exist.

The antiviral composition 1 (inorganic compound 3) can not only adsorb viruses but also eliminate (inactivate) the adsorbed viruses.

The inorganic compound 3 may have an antibacterial property as well as an antiviral property. In this case, “antiviral composition” may be referred to as “antibacterial and antiviral composition”. The antibacterial and antiviral composition 1 can adsorb not only viruses but also bacteria, prevent the growth of the adsorbed bacteria, and kill (sterilize) the adsorbed bacteria.

The inorganic compound 3 is made from Shirasu (Shirasu that has not been subjected to any processing such as heat treatment, for example). Shirasu 3 is popularly known as white sandy sediment and is a generic term for white coarse volcanic ejecta widely distributed in southern Kyushu and secondary sediment derived therefrom. In the shirasu 3, crystallization differentiation occurs due to cooling of high-temperature magma, and main components in magma such as SiO₂, Al₂O₃, Fe₂O₃, MgO, CaO, Na₂O, and K₂O come together with each other. The shirasu 3 was formed through explosive eruption shortly after crystallization as minerals, and made from about 30% crystalline mineral and the remaining 70% amorphous volcanic glass.

This amorphous volcanic glass is formed as a porous pumice through the rapid emission of volatile components in the magma, and contains 65% to 73% SiO₂, 12% to 16% Al₂O₃, 2% to 4% CaO, 3% to 4% Na₂O, and 2% to 4% K₂O, and 1% to 3% iron. The crystalline mineral contains the largest amount of plagioclase, and also contains a small amount of hypershene, quartz, augite, and magnetite.

### <Shirasu>

Shirasu is what forms the Shirasu Plateau. The Shirasu Plateau extends up to 150 meters in thickness from Kagoshima Prefecture to southern Miyazaki Prefecture in Japan.

Shirasu was deposited all at once as a large amount of pyroclastic flow, and thus it does not mix with other soil and becomes to be a thick layer, forming the Shirasu Plateau. Typical soil is a finely ground powder of rock mixed with a variety of organic matter through the action of plants and microorganisms.

In contrast, Shirasu contains little nutrients (organic matter) because it is made into powder before magma becomes rock, and is a high-purity inorganic ceramic material fired at extremely high temperature from the state of magma. That is, Shirasu is a porous material mainly made from volcanic glass and contains 60% to 80% silicic acid.

The analysis result of Takachiho Shirasu (Shirasu from Mt. Takachiho, Kyushu) in % by weight is as follows.

The ignition loss is 2.7%, SiO₂ is 67.8%, Al₂O₃ is 15.10%, Na₂O is 3.7%, CaO is 2.2%, Fe₂O₃ is 2.5%, K₂O is 2.2%, TiO₂ is 0.27%, MnO is 0.06%, MgO is 0.58%, P₂O₅ is 0.03%, SO₃ is 0.20%, and Cl⁻ is less than 0.001%.

The ignition loss is due to sulfur trioxide (SO₃), which is measured according to JIS R5202. Silicon oxide (IV) (SiO₂) was measured using a combination of coagulation gravimetric method and abosorptiometry. Aluminum oxide (Al₂O₃), iron oxide (III) (Fe₂O₃), titanium oxide (IV) (TiO₂), calcium oxide (CaO), magnesium oxide (MgO), sodium oxide (Na₂O), potassium oxide (K₂O), manganese oxide (MnO), and phosphorus pentoxide (P₂O₅) were measured using hydrofluoric acid, nitric acid, and perchloric acid decomposition-ICP optical emission spectrometry. Chloride ions (Cl⁻) were eluted according to Notice No. 13 of the Ministry of the Environment, and the test solution was measured using ion chromatography.

Note that Shirasu other than Takachiho Shirasu (for example, Shirasu from Kagoshima) or a composition having the same composition as Takachiho Shirasu may be used instead of Takachiho Shirasu.

To explain further, the main components of Shirasu are silicic acid and aluminum oxide, and plagioclase, quartz, and titanium oxide are also included. There are a large number of minute air bubbles in Shirasu particles.

Shirasu, which is smooth and powdery, is treated as a nuisance because it is not suitable for paddy fields due to poor water retention and is prone to cause landslides during heavy rains.

### <Inorganic Compound Having Antibacterial and Antiviral Properties>

A redox reaction occurs on the surface of Shirasu, and this has confirmed the antibacterial and antiviral properties of Shirasu recently. In addition, there are a large number of minute air bubbles 5 in the particles of the shirasu 3, although not as small as in Shirasu balloon, which will be described in detail below. Thus, the shirasu 3 has a porous structure where physical adsorption occurs in its micropores and mesopores, and can exhibit an adsorption property against viruses and the like in the air.

Note that Shirasu balloon may be employed instead of or in addition to employing the shirasu 3 without heat treatment or other processing almost as it is. Shirasu-balloon is a fine balloon-like material (particulate hollow bodies) obtained by firing and foaming Shirasu at a high temperature of about 1,000° C. Shirasu-balloon has various features such as colorlessness and harmlessness, low bulk specific gravity, non-flammability, high melting point, low thermal conductivity, and high chemical resistance, high moisture absorption, and high sound absorption. Note that in FIG. 1, the inorganic compound 3 represents Shirasu-balloon, which will be described in detail below.

In the antiviral composition 1, at least one additive of a curing agent, a plasticizer, a pigment, a reinforcing agent, a lubricant, an antioxidant, an adhesion imparting agent, or a bonding agent may be added to the inorganic compound 3.

Even when an additive is added, almost all of the surface of the inorganic compound 3 is not covered with the additive. Even when an additive is added, the inorganic compound (especially Shirasu-balloon) 3 including Shirasu as it is has a porous structure in which many air bubbles 5, and micropores and mesopores are formed, and a large part of the surface of the inorganic compound 3 is exposed by the action of the surface tension of the additive, and the like. The additive covers only a small part of the surface of the inorganic compound 3. Note that the surface of the inorganic compound 3 refers not only to an outer peripheral surface 7 of the inorganic compound 3 (antiviral composition 1) illustrated in FIG. 1, but also to surfaces 9 of void parts (cavity; air bubbles) 5 of the inorganic compound 3, and surfaces 13 of hole parts 11 connecting the void parts 5 of the inorganic compound 3 each other. Note that hole parts 11 connect void parts 5 of the inorganic compound 3 and the outside of the inorganic compound 3 each other.

The inorganic compound 3 has a particle shape with an average particle size of 250 μm or less. To explain further, the inorganic compound 3 has a particle shape with an average particle size of 1 μm or more and 250 μm or less, 5 μm or more and 250 μm or less, 10 μm or more and 250 μm or less, 20 μm or more and 250 μm or less, 50 μm or more and 250 μm or less, 100 μm or more and 250 μm or less, or 150 μm or more and 250 μm or less. “Average particle size” means, for example, the particle size at an integrated value of 50% in the particle size distribution determined using laser diffraction/scattering method.

Incidentally, the inorganic compound 3 may have a particle shape with an average particle size of 200 μm or less. To explain further, the inorganic compound 3 may have a particle shape with an average particle size of 1 μm or more and 200 μm or less, 5 μm or more and 200 μm or less, 10 μm or more and 200 μm or less, 20 μm or more and 200 μm or less, 50 μm or more and 200 μm or less, 100 μm or more and 200 μm or less, or 150 μm or more and 200 μm or less. When the inorganic compound 3 is Shirasu-balloon, it is desirable that the average particle size of this Shirasu-balloon be 145 μm or less (for example, 5 pim or more and 145 μm or less, more preferably 105 μm or more and 145 μm or less).

### <Antiviral Member>

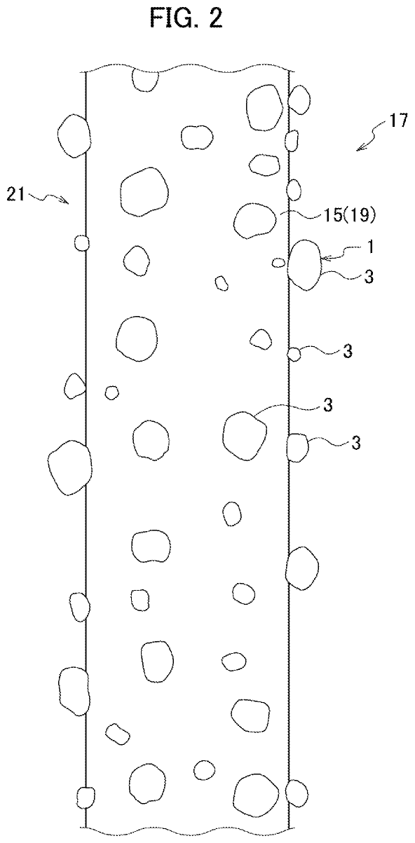

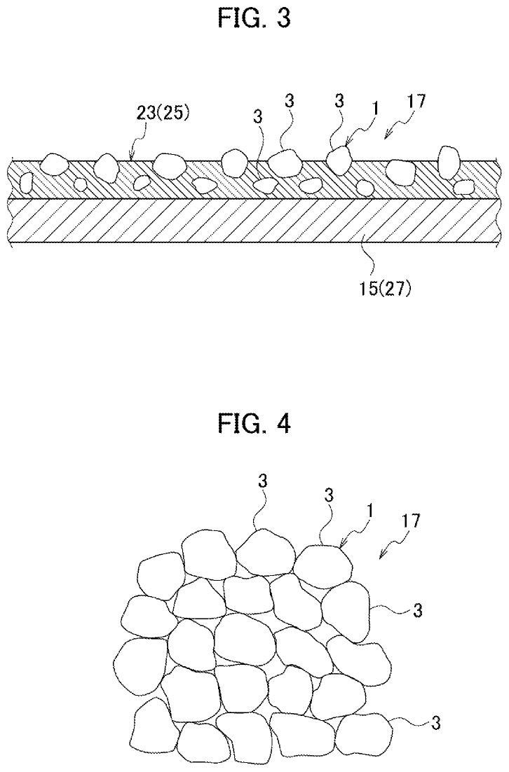

As illustrated in FIGS. 2 and 3, an antiviral member (antibacterial and antiviral member) 17 may be obtained by installing the antiviral composition (antibacterial and antiviral composition 1) on a base material 15.

Forms of the antiviral member 17 and the antiviral composition 1 are not particularly limited and include various shapes such as fibers, fabrics such as non-woven fabrics, meshes, films, coating films, thin films, sheets, blocks (see FIG. 4), walls, particles, rods, plates, sponges, solutions, paints, gels, and creams.

Thereamong, fabrics such as non-woven fabrics, sheets, coating films, blocks, walls, and particles are preferable. The antiviral composition 1 can also be preferably used by dissolving or dispersing it in water or a mixture of water and an organic solvent such as an alcohol, and spraying the solution.

The antiviral member 17 (antiviral composition 1) may be formed into a fiber shape and used as a fabric. The antiviral composition 1 is applied to the surface of an untreated fiber 19 (corresponding to the base material 15 described above) (for example, attached by using an additive such as a bonding agent) to form a fiber (antiviral composition attached fiber) 21 having the antiviral composition 1 on the surface thereof (see FIG. 2). The fiber 21 may be made into a fabric in a conventional manner. Further, the antiviral composition 1 may be attached to an untreated fabric by using an additive, for example, so as to provide a processed fabric having the antiviral composition 1 on the surface thereof.

The above processed fabric can easily add antiviral performance to an ordinary fabric. In the above processed fabric, a method for applying the antiviral composition 1 includes a dipping method, a spraying method, a printing method, and an applying method.

The above processed fabric includes any fabric structure regardless of whether it is a woven fabric, a knitted fabric, or anon-woven fabric. Examples of the fabric material include natural fibers such as cotton, hemp, and wool, recycled fibers such as rayon, semi-synthetic fibers such as acetate and triacetate, and synthetic fibers such as polyester, nylon, acrylic, polypropylene, and polyethylene.

The antiviral composition 1 may be contained in a paint for coating film, or a processed coating film (antiviral composition containing-processed coating film) 25 may be manufactured from a paint for coating film (antiviral composition containing-paint for coating film) 23 containing the antiviral composition 1 (see FIG. 3).

The antiviral composition containing-paint for coating film 23 and the antiviral composition containing-processed coating film 25 manufactured from the antiviral composition containing-paint for coating film 23 are formed into a film and applied to a coated object 27 (corresponding to the base material 15). Thus, the antiviral performance can be easily and widely added to the coated object 27. Note that the antiviral composition containing-processed coating film 25 also includes a sheet containing the antiviral composition 1.

As a method for manufacturing the antiviral composition containing-processed coating film 25 from the antiviral composition containing-paint for coating film 23, the antiviral composition 1 is coated by means of coating, spraying, or the like on the coated object 27, and then dried. The coated object 27 can be used for materials such as paper, metal, and plastic, and can also be used for flat surfaces such as sheets and films, and non-flat surfaces such as door knobs, straps, and handrails.

The antiviral composition 1 may be contained in a wall covering material. The wall covering material containing the antiviral composition 1 (antiviral composition containing-wall covering material) is used, for example, for the interior and exterior wall surfaces of a house and the like.

With the antiviral composition containing-wall covering material and the interior and exterior wall surfaces manufactured from the wall covering material, the antiviral performance can be easily and widely added to a wall member to be covered. As a method for manufacturing interior and exterior wall surfaces using the above wall covering material, the antiviral composition 1 is coated on a base material (coated object) constituting a wall by means of coating, spraying, a trowel, or the like, and then dried. The above wall member to be covered includes stone cladding, brickwork, decorative mortar coating, diatomite-coated wall, sand wall, tiled wall, natural wood wall, printed decorative plywood, and decorative steel panel.

Applications of the antiviral composition 1 include wall materials, floor materials, curtains, clothes, laundry glue, fabric softener, soap, garbage cans, food packaging materials, adhesive bandages, bandages, filters (air purifiers), bedding (blankets, futons, and sheets), seats (car seats, train seats, and aircraft seat), sponges (for cleaning, dishwashing, and filtering materials), diapers, cleaning tools, contamination spreading prevention materials, and sprays.

In addition, the antiviral composition 1 in a block shape illustrated in FIG. 4 may be formed into a suitable shape, and the formed product may be adopted as an ornament placed indoors or a monument placed outdoors.

A method for manufacturing Satsuma Nakagirishima wall using the antiviral composition 1 will now be described.

The antiviral composition 1 was obtained by kneading 80% (wt %) Shirasu obtained by removing impurities and then drying, 15% (wt %) white cement or gypsum, 4% (wt %) reinforcing material such as straw grass or hemp, and 1% (wt %) pigment coloring material with addition of an appropriate amount of water to form a paste.

Shirasu plaster wall using the antiviral composition 1 was also manufactured in the same manner as Satsuma Nakagirishima wall using the antiviral composition 1.

To explain further, Shirasu plaster wall is obtained by kneading 80% (wt %) Shirasu obtained by removing impurities and then drying, 15% (wt %) slaked lime, 4% (wt %) reinforcing material such as straw grass or hemp, and 1% (wt %) pigment coloring material with addition of an appropriate amount of water to form a paste state.

### <Evaluation of Antiviral Composition>

A wall of Satsuma Nakagirishima using the obtained antiviral composition 1 and a wall of Shirasu plaster wall using the obtained antiviral composition 1 are each applied with a trowel or the like to a thickness of about 5 mm on a base such as gypsum plasterboard, a plywood board, a concrete board, a mortar water-resistant plywood, or an asbestos board, having a thickness of about 12 mm. Then, antibacterial and antiviral wall materials are obtained after drying. Note that flat square shapes with a side of 1.0 cm was cut out from the antibacterial and antiviral wall materials to form specimens.

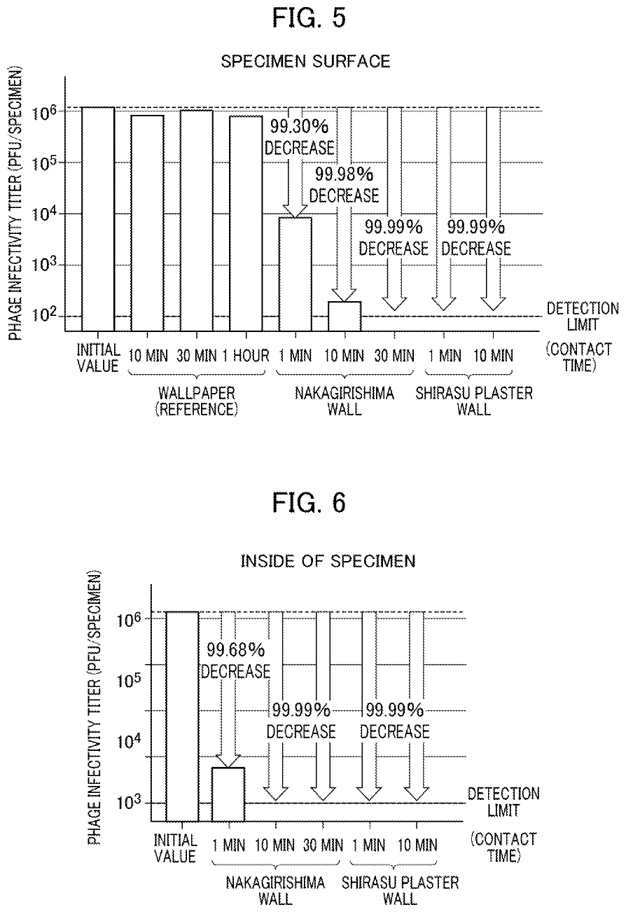

FIG. 5 shows the result of infectivity titer measurement (phage Qβ) on the surface of specimens. The initial value of the phage infectivity titer (PFU/specimen) is about 10⁶. Even after the passage of time, the inactivation of phage is hardly observed in the infectivity titer of a comparative example, but the decrease in phage infectivity titer of 99% or more is observed in the wall of Satsuma Nakagirishima using the antiviral composition 1 and the wall of Shirasu plaster using the antiviral composition 1.

FIG. 6 shows the result of infectivity titer measurement (phage Qβ) inside the specimens. In the wall of Satsuma Nakagirishima using the antiviral composition 1 and the wall of Shirasu plaster using the antiviral composition 1, a decrease in the phage infectivity titer of 99% or more is observed.

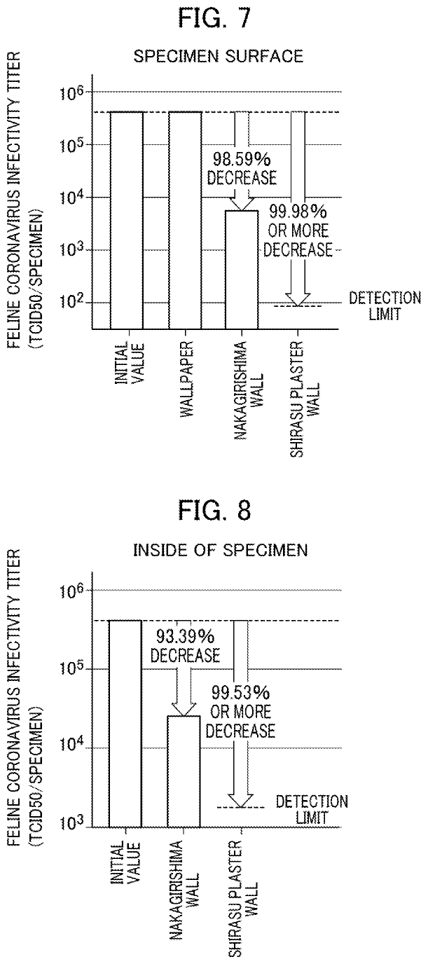

FIG. 7 shows the result of infectivity titer measurement (feline coronavirus) on the surface of specimens. The initial value of feline coronavirus infection titer (TCID50/specimen) is a value between 10⁵ and 10⁶. Even after the passage of time, the inactivation of feline coronavirus is hardly observed in the infectivity titer of a comparative example, but the decrease in feline coronavirus infection titer of 98% or more is observed in the wall of Satsuma Nakagirishima using the antiviral composition 1 and the wall of Shirasu plaster using the antiviral composition 1. Note that the contact time in FIG. 7 is 1 minute.

FIG. 8 shows the result of infectivity titer measurement (feline coronavirus) inside the specimens. The initial value of feline coronavirus infection titer (TCID50/specimen) is a value between 10⁵ and 10⁶. In the wall of Satsuma Nakagirishima using the antiviral composition 1 and the wall of Shirasu plaster using the antiviral composition 1, a decrease in feline coronavirus infection titer of 93% or more is observed. Note that the contact time in FIG. 8 is also 1 minute.

In the antiviral composition 1, the inorganic compound 3 has an antiviral property and has a porous structure. Thereby, viruses floating in the air can be physically adsorbed on the surface of the inorganic compound 3 (including micropores and mesopores) and disappeared. In addition, compared with the case where a chemical agent such as hypochlorous acid or hydrogen peroxide is used, handling and safety are superior, the impact on the human body or the environment is eliminated, and the effect is sustained. Note that when the antiviral composition 1 also has an antibacterial property, bacteria floating in the air can be adsorbed on the surface to prevent the growth of bacteria and kill the adsorbed bacteria.

In the antiviral composition 1, since the inorganic compound 3 is made from Shirasu, the antiviral composition 1 can be produced inexpensively using a common material. In addition, by using Shirasu, which mainly includes SiO₂ and Al₂O₃, as a material for exhibiting antibacterial and antiviral properties, it is possible to obtain antibacterial and antiviral properties capable of adsorbing and disappearing bacteria and viruses floating in the air and to realize a high immediate effect.

Since the antiviral composition 1 contains Shirasu, the growth of bacteria and viruses can be suppressed. Compared with conventional antibacterial and antiviral materials, the antiviral composition 1 also has excellent handling and excellent safety.

In the antiviral composition 1, at least one additive of a curing agent, a plasticizer, a pigment, a reinforcing agent, a lubricant, an antioxidant, an adhesion imparting agent, or a bonding agent may be added to the inorganic compound 3. Thus, the form of the antiviral composition 1 can be appropriately changed, and the usability of the antiviral composition 1 can be improved. Note that even when an additive is added, since most of the surface of the inorganic compound 3 is exposed, functions such as adsorption in the antiviral composition 1 are hardly impaired.

The average particle size of the inorganic compound 3 is 250 μm or less in the antiviral composition 1, and thus when the antiviral composition 1 is used as particles, the antibacterial and antiviral performance can be exhibited in a short period of time. In addition to being excellent in handling and safety, the antibacterial and antiviral performance can be exhibited even in a small amount by being dispersed or dissolved in a solvent. When the average particle size is 250 μm or less, the effect can be exhibited in as little as 1 minute after contact with a virus.

In the antiviral composition 1, when the antiviral composition 1 is installed on the base material 15, the form of the antiviral member provided with the antiviral composition 1 can be appropriately changed, and the usability of the antiviral composition 1 (antiviral member) can be improved.

Although the present embodiment has been described above, the present embodiment is not limited to these descriptions, and various modifications are possible within a scope of the gist of the present embodiment.

The present invention has an effect of providing an antiviral composition which is capable of adsorbing viruses floating in the air on a surface thereof and eliminating them, and has excellent handling and excellent safety, and providing an antiviral member using the antiviral composition.

### (U.S. Designated)

This international patent application claims priority benefits under 35 U.S.C. 119(a) of Japanese Patent Application No. 2021-089882, filed on May 28, 2021, with respect to the U.S. designation, and the entire contents thereof are incorporated herein by reference.

1. An antiviral composition, comprising:
an inorganic compound having an antiviral property and a porous structure.

2. The antiviral composition according to claim 1, wherein the inorganic compound is made from Shirasu.

3. The antiviral composition according to claim 1, wherein at least one of a curing agent, a plasticizer, a pigment, a reinforcing agent, a lubricant, an antioxidant, an adhesion imparting agent, or a bonding agent is added to the inorganic compound.

4. The antiviral composition according to claim 1, wherein the inorganic compound has a particle shape with an average particle size of 250 μm or less.

5. An antiviral member, comprising:
a base material; and
the antiviral composition according to claim 1 which is installed on the base material.
